(19) United States
(12) Patent Application Publication
(10) Pub. No.: US 2016/0306798 A1
(43) Pub. Date: Oct. 20, 2016

(54) CONTEXT-SENSITIVE CONTENT RECOMMENDATION USING ENTERPRISE SEARCH AND PUBLIC SEARCH

(71) Applicant: Microsoft Corporation, Redmond, WA (US)

(72) Inventors: Chenlei Guo, Redmond, WA (US); Yeyi Wang, Redmond, WA (US); Jianfeng Gao, Woodinville, WA (US); Ashish Garg, Bellevue, WA (US); Karen Stabile, Bellevue, WA (US); Divya Jetley, Bellevue, WA (US)

(73) Assignee: MICROSOFT CORPORATION, Redmond, WA (US)

(21) Appl. No.: 14/688,872

(22) Filed: Apr. 16, 2015

(51) Int. Cl. G06F 17/30

(52) U.S. Cl. CPC G06F 17/30011; G06F 17/30554; G06F 17/30528

(57) ABSTRACT

Architecture that recommends (suggests) personalized and relevant documents from internal networks and/or public networks (search engines) to help the user complete/update a document currently being worked. The architecture extracts the query and uses the context to perform the search, and performs the search from within the editing application, using the entire text of the document to improve relevance. User context and textual/session context are employed to search for relevant documents. Relevant documents are proactively recommended when the user is authoring the document within an authoring application. The search operation is performed reactively using authoring context (e.g., user, textual, session, etc.) in authoring applications. Results are recommended from both internal documents (e.g., local storage, corporate network, etc.) and public documents (e.g., using a public search engine). Moreover, a deep neural network (DNN) can be utilized to re-rank the documents using both personalized features and context-sensitive and/or context-free features.

### BACKGROUND

Given the ever-increasing amount of data being created and stored, it becomes correspondingly important to provide search technologies that can enable searching these vast amounts of data in an efficient and reasonable amount of time. Search typically involves web content; however, such general and leisurely searches do not satisfy the more focused and useful searches now in demand by users.

Current solutions require users to formulate their own queries, to leave the document they are editing and use a browser to search, and to use only a few keywords entered to find results, which in many cases is inadequate or inefficient.

### SUMMARY

The following presents a simplified summary in order to provide a basic understanding of some novel implementations described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture recommends (suggests) personalized (relates to the user) and relevant documents from internal networks (e.g., local storage, corporate network, private cloud service, public cloud service, etc.) and/or public networks (search engines) to help the user complete/update a document currently being worked or a previously-completed document now being updated. The disclosed architecture extracts a query and/or takes a user-supplied query, and uses overall context (e.g., authoring context and/or user context) to perform the search, and performs the search from within the editing (authoring) application, using some or the entire text of the document to improve results relevance. In other words, the query can be generated without the user taking any extraordinary action. For example, the query can be generated based on a last word the user has typed, without the user knowing this is being performed. In some cases, the query can be obtained based on user submission from within the document, but this is not a requirement. The architecture extracts a query and performs a search using the query and additional context information, such as content from the document currently being worked.

The query employed is not a typical short-term query, although it can be, but comprises what the user is doing overall in the entire authoring application. This can include a system “understanding” of what the document being authored, is about. This understanding (or machine readable summary) can be a synthesis of the entire document, which can include images, links, headings, audio, metadata (e.g., images), and so on. In one implementation, the architecture analyzes the full document, looks at the part of the document the user is currently working (“working location”) (a partial query using structure information such as nearby section headings, distance to headers, paragraph sentences, page number, etc.), and uses the user working location in relation to the entire document as metadata to that partial query to make the whole query.

The disclosed architecture employs user context (e.g., who you are, where you are, what you are doing, etc.) and/or textual/session (authoring) context to search for relevant documents. Highly relevant documents are proactively recommended when (during the time) the user is authoring the document within an authoring application. Additionally, the search operation is performed reactively using context (e.g., user, textual, session, etc.) in authoring applications. Results (all types and combinations of content, e.g., images, video, text, etc.) are recommended from internal documents (e.g., local storage, corporate network, etc.) and/or public documents (e.g., using a public search engine). The enterprise search (as relates to the user working on the working document) enables the capability to store enterprise documents on-premise and/or in the cloud with scoped permissions (e.g., OneDrive). Moreover, as a feature of an example embodiment, a deep neural network (DNN) can be employed (although this is not a requirement) in ranking and re-ranking of the documents using both personalized features and context-sensitive and/or context-free features.

The architecture can be implemented as a system, comprising a context component configured to identify overall context as comprising authoring context in association with a user working on a working document via an authoring application, the overall context identified in association with a query generated while the user is working on the working document. The overall context can also comprise user context identified as the information collected over time of the user interests and behaviors. The system can also comprise a query component configured to formulate and facilitate search using the overall context as a contextual query, where the search is performed using the contextual query alone or in combination with the user query, to obtain at least one of search results that comprise internal network results of an internal network or public results of a public network, and a presentation component configured to present the search results in association with the authoring application.

The disclosed architecture can be implemented as an alternative system comprising: means for receiving a query while a user is authoring a working document using an associated authoring application; means for identifying user context and authoring context in association with the user authoring the working document; means for receiving search results that comprise internal network documents of an internal network and, optionally, public documents of a public network based on processing of the user context and the authoring context in a search process; and means for presenting the search results in the authoring application.

The disclosed architecture can be implemented as yet another alternative system, comprising: means for identifying user context and authoring context based on a query by a user working on a working document using an authoring application; means for receiving search results that comprise internal network documents of an internal network and public documents of a public network based on processing of the user context and the authoring context in a search process; and means for presenting the search results in the authoring application.

The disclosed architecture enables at least the technical effects of improved usability, effectiveness and efficiency in search regimes. For example, the capability provided to enable search for relevant documents while document authoring improves user interaction performance not only in document completion and information accuracy, but also reduces the time that would otherwise be needed to complete projects and tasks. Moreover, the presentation of the search result in the authoring application eliminates the need to employ one or more other applications for task completion.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system in accordance with the disclosed architecture.

FIG. 3 illustrates an alternative system for context-sensitive content recommendation in accordance with the disclosed architecture.

FIG. 4 illustrates a method in accordance with the disclosed architecture.

FIG. 5 illustrates an alternative method in accordance with the disclosed architecture.

FIG. 6 illustrates a block diagram of a computing system that executes context-sensitive content recommendation from internal search networks and public search networks in accordance with the disclosed architecture.

### DETAILED DESCRIPTION

Given a working document (e.g., word processing document, presentation document, spreadsheet document, etc.), the disclosed architecture recommends (suggests) personalized (related in some way to the user, e.g., user intent of the query) and relevant documents from internal networks (e.g., local storage, corporate network, private/public cloud services, etc.) and public search engines to help the user complete the document. While traditional limitations require users to formulate queries, the disclosed architecture extracts the query and uses the overall context to perform the search, and performs the search from within the editing application, using the entire text of the document to improve relevance.

Automatic query extraction can be achieved according to techniques that, for example, identify user location in the working document, document topic at or proximate that location, document content and/or content type at or near that location, term frequencies at or near that location, term distances, document page number, and so on. Zero, one, or more of these attributes, and other attributes not listed here, may be used as features of a contextual query automatically passed to the search engines(s) to return results. (A query refers to information that can be specified (e.g., input, tagged, interacted with, etc.) by a user with the intent of retrieving one or more documents or automatically extracted and generated for the user. The query conveys query information, which, for example, may correspond to the terms specified by the user, which make up the query.)

Feedback can also be employed to improve the architecture. The feedback can comprise how the user interacts with the results returned by the architecture. Positive feedback comprises when the user selects (“clicks”) content or interacts with the content. Feedback signals can be used by the architecture over time to improve ranking (e.g., by tuning the ranker to user preferences).

In traditional attempts, when a user is authoring a document (e.g., word processing document, presentation document, spreadsheet document, etc.) in a given application, the user will need to use a browser and a public search engine to find related content (e.g., content such as documents, images, video, etc.) by formulating multiple queries that can represent the context of the current state of the document. Once the user is satisfied with the search results, the user then will download and copy-paste the content into the current document.

The disclosed architecture employs user context (e.g., who you are, where you are, what you are doing, etc.) and textual/session context to search for relevant documents. Highly relevant documents are proactively recommended when (during the time) the user is authoring the document within an authoring application. Additionally, the search operation is performed reactively using context (e.g., user, textual, session, etc.) in authoring applications. Results are recommended from both internal documents (e.g., an enterprise search that enables the capability to store enterprise documents on-premise and/or in the cloud with scoped permissions) and public documents (e.g., using a public search engine). Moreover, a deep neural network (DNN) is utilized to re-rank (and even initially, rank) the documents using both user (“personalized”) features and context-sensitive and/or context-free features. Multiple results can be presented (displayed) for a user selection in a case of ambiguity.

A DNN refers to any model that outputs underlying semantic content using a linguistic item as the input. In one implementation, the model may correspond to a multilayered neural network, also referred to as the deep neural network.

A document refers to any content-bearing item against which the query is compared. In one case, a document corresponds to a discrete text-bearing content item produced by any document-creation tool, corresponding to any topic(s), and expressed in any format(s). For example, the document may correspond to a text document produced by a word processing program, an email message produced by an email program, an image having textual tags or annotations, a webpage or other Internet-accessible content item, and so on.

In another case, a document may correspond to any record in any type of data structure, or in any unstructured repository of records. For example, a document may correspond to an entry within a table, a node associated with a knowledge graph, and so on. For instance, in one case, a document may pertain to a person (e.g., identify the person, include a biography of the person, use the person's name multiple times, etc.) identified by an enterprise graph; that person, in turn, may be associated with text-bearing content, such as content (e.g., an email message, etc.) authored by and/or consumed by the person. The search engine can optionally rely on an indexing mechanism to retrieve documents, given specified search terms.

In one particular case, a document specifically pertains to an entity, such as a person, place, thing, etc. Such a document may be referred to as an entity document. A particular entity, in turn, pertains to any focus of interest, such as person, place, location, product, and so on. An entity document may include various entity components which describe different characteristics of the entity to which it pertains. For example, the entity components may describe the title of the entity, the attribute values associated with the entity, other documents associated with the entity document, the queries that users have submitted to access the entity document, and so on.

A context describes a circumstance in which a user has submitted a query, as expressed by context information. (Alternatively, the query can be generated proactively, without user submission. Context does not necessarily depend on explicit action from the user.) For example, in one case, a user may input a query by selecting one or more words then identified as search terms which appear within some source document, such as a web page, an email, etc. That is, the selected terms constitute the query, and can then be interpreted as user intent. The context information for that query may comprise words that occur in proximity to the query within the source document and/or a word distance value of a specific word from the query, the same document page, and so on. More specifically, the context information for the query may correspond to n words or alphanumeric characters that occur prior to the query in the source document, and m words or alphanumeric characters that occur after the query in the source document (where n and m are integers, and n=m in some cases, and n≠m in other cases).

Alternatively, or in addition, the context information may describe any demographic characteristic of the user who has submitted the query. For example, the context information may describe one or more of age, gender, educational level, profession, interests, etc., of the user.

Alternatively, or in addition, the context information may describe the prior behavior of the user. For example, the context information may correspond to previous queries submitted by a user within some window of time, and/or over some number of previous user sessions, etc. The context information may also describe the selections (e.g., clicks) made by the user within some window of time and/or over some number of previous user sessions. As used herein, a “click” describes any manner by which a user may express interest in a document. For example, in some cases, a user may select a document in a search results page by explicitly clicking on the document using a mouse device or the like, using one or more keyboard key selections/actions, or touching the document on a touch sensitive user interface presentation, etc. In other cases, a user may select a document by hovering over it using any input device. In other cases, a user may select document by performing some transaction that pertains to the document, such as by filling out a survey, purchasing a corresponding product, and so on.

A session refers to a user interaction with any user computing device, and/or any program (such as a browser program), demarcated by login/logoff events, time, and/or any other factors.

Alternatively, or in addition, the context information may describe the social contacts associated with the user. The search engine may extract that information from any source, such as contact information maintained by the user using a social network service, etc.

Alternatively, or in addition, the context information may describe the location at which a user has submitted a query. The search engine may determine the location of the user based on any position-determination mechanisms, such as satellite-based mechanisms (e.g., GPS (global positioning system) mechanisms), triangulation mechanisms, dead-reckoning mechanisms, and so on. Alternatively, or in addition, the context information may describe the time at which a user has submitted a query or the query is proactively submitted (e.g., by the system).

The context information may describe yet other circumstances pertaining to the submission of the query. The above examples of context information are cited by way of example, not limitation. In connection therewith, the search engine can apply appropriate safeguards to ensure that any personal data associated with the user is handled in an appropriate manner. For example, the use of user profile information can be handled by obtaining permission by the user to employ this information as part of the user context for automatic query generation. It can also be the case that user information obtained from a social network is securely handled to ensure anonymity, if desired, relative to exposure to other users as to the search engine indices generated. The context information may also comprise temporal context such as time of day, day of week, holiday, etc.

In one implementation, the DNN can be trained as a deep structured semantic model (DSSM) as the base model. (It is to be understood that, in another implementation, the representation of context can be obtained using other models suitable for this purpose.) The DSSM performs associated functions based on respective instances of the deep learning module. The DSSM may be implemented as a DNN, composed of a plurality of layers. For example, in one implementation, the DSSM can comprise four layers, but more generally, the DSSM can include any number of layers. Each layer, in turn, includes a plural of elements, referred to as neurons, where each neuron stores a value. Each neuron, in a given layer, is furthermore connected to zero, one, or more neurons in an immediately anterior layer (if any), and zero, one, or more neurons in an immediately posterior layer (if any).

Here, “anterior” and “posterior” refer to adjacent layers in relation to a direction of information flow through the DNN (e.g., from bottom to top) with respect to a given layer, anterior layers represent lower layers, while posterior layers represent higher layers.

The layers include a bottommost layer for storing values as a bottommost vector, where the bottommost layer represents the input to the DSSM. A second layer stores a second vector having values that are derived from the values in the bottommost layer, and so on, through the number of layers employed. A final output (or topmost) layer stores a concept vector having values that are derived from the values in the previous layer.

As a general notion, the disclosed architecture can comprise one or both of server-side capabilities and client-side capabilities. On the server side, an enterprise search can be provided that utilizes an enterprise index (e.g., via Sharepoint™ search API (application program interface)) to fetch candidate documents. People relationships can then be obtained from Office Graph™ to generate document-to-people features as personalized features, and use the DNN to generate contextual feature vectors to represent authoring context.

Applications such as Office Graph™, Delve™, etc., enable the incorporation of web searches and online interactions to highlight files and projects the application determines to be important to the user, based on whom the user is speaking to (or communicating). The application can also enable the user to see how the user is connected though people or projects to others in the user's organization. The application also provides a function that enables the sharing of email, files, and calendars across a group of coworkers. A DNN can then be trained in the output layer to generate a ranking score for each document candidate.

As to search engines for the public domain, Bing™ and/or other search engines can be used as the source of public documents, and then use the DNN to generate additional contextual features as the input of search engine (e.g., Bing™) ranker to re-rank the documents.

On the client side, the authoring application, for example, in one implementation the user interface in Powerpoint™, sends a recommendation request to both the internal network (e.g., personalized enterprise search) and the public network (e.g., Bing™ search), both proactively and reactively. When the client receives responses, the results are shown in the Powerpoint™ application (e.g., in a right pane or panel). The user can then add the application document (or “slide”) to the user's current document deck using a single “click”.

Reference is now made to the drawings, wherein like reference numerals are used to refer to like elements throughout. In the following description, for purposes of explanation, numerous specific details are set forth in order to provide a thorough understanding thereof. It may be evident, however, that the novel implementations can be practiced without these specific details. In other instances, well known structures and devices are shown in block diagram form in order to facilitate a description thereof. The intention is to cover all modifications, equivalents, and alternatives falling within the spirit and scope of the claimed subject matter.

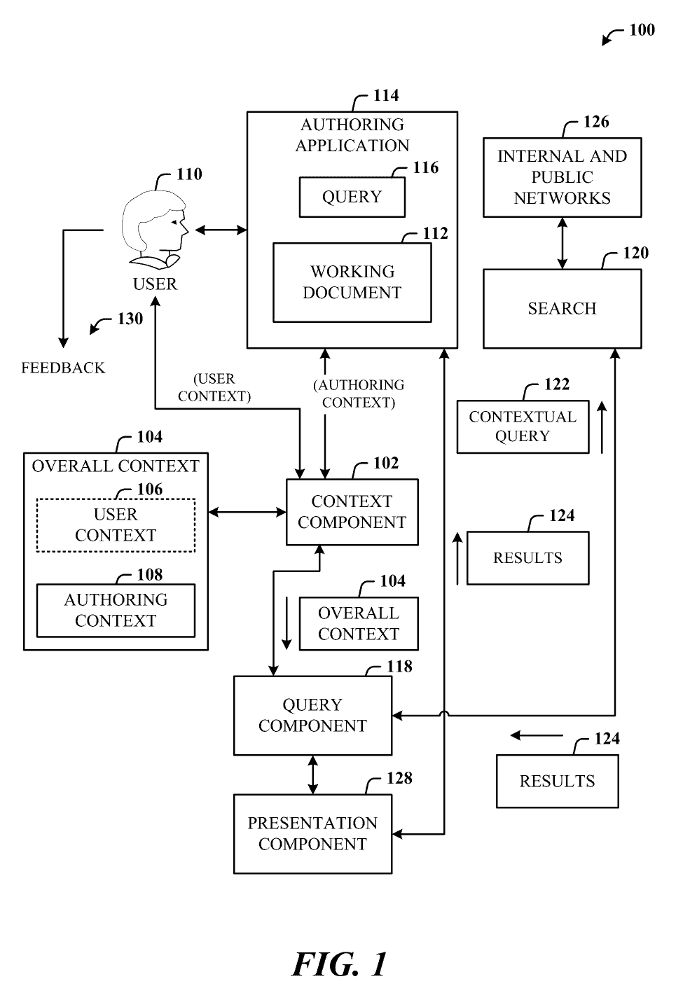

FIG. 1 illustrates a system 100 in accordance with the disclosed architecture. The system 100 can include a context component 102 configured to identify overall context 104 as comprising authoring context 108 in association with a user 110 working on a working document 112 (e.g., being created or a previously-completed document now being updated) via an authoring application 114.

User context 106 can be computed and defined as including “who, what, where, and when” information associated with the user 110 at a given point in time. The “who” information is the identity of the user 110, which identity information can then be used further to obtain more focused information such as profiles, location, etc.

The “who” information is the identity of the user 110, which can include one or more user profiles of the user 110. The profiles can be comprise device-specific preferences (the user 110 typically uses a desktop computer when in the office and a tablet computer when travelling, etc.), and application-specific preferences (the user 110 has a history of using the spreadsheet program in the morning and a word processing application in the afternoon, etc.). It can also be a combination of device-specific information and application-specific information. For example, the user profile indicates the user typically uses a word processing application on a tablet and a basic texting application on a smartphone.

The “where” information can indicate the physical location of the user, such as in the office, at the airport, on vacation, at the Grand Canyon, at an entertainment event, shopping, etc. The “when” information can indicate not only the time of certain events (currently working on a spreadsheet document), but also time relative to other events. For example, the user is currently engaged with a spreadsheet application, but only a few minutes ago, was actively engaged with a browsing application.

The overall context 104 can be identified in association with a query 116 (e.g., generated by the user 110) while the user 110 is working on the working document 112. In other words, once the user 110 interacts with the authoring application 114, the system 100 reacts to capture the “who, what, where, when” information to identify the overall context 104 (which may also be configured to determine user context) at the specific moment in time. Alternatively, the system 100 can periodically capture (e.g., every two minutes) the overall context 104 or continually capture the overall context 104 until a query event triggers identification of the overall context 104 at the specific moment in time. Note that the user context 106 can be utilized to determine relevant results, and optionally (indicated by dotted-line block), in the overall context 104.

A query component 118 is provided and configured to formulate and facilitate search 120 (and results handling) using the overall context 104 as a contextual query 122. (The search 120 represents hardware and software (e.g., a search engine and associated components) that enable the processing of the query 116 and the ranking, re-ranking, and return of the results 124.) The search 120 is performed using the contextual query 122 alone or in combination with the query 116, to obtain search results 124 that comprise results of internal and public networks 126 (e.g., internal network results of the internal network, public results of the public network, or both). The query 116 can be initiated from within the authoring application 114. The search results 124 can be presented in the authoring application 114 and a search result can be selected and inserted into or appended to the working document 112.

A presentation component 128 is provided and configured to present the search results 124 in association with the authoring application 114. The presentation component 128 can be part of the authoring application 114 that enables the display of information in windows, panels, viewports, etc., of the authoring application 114. For example, when results are received into the authoring application 114, the results can be presented in a side panel that is opened on the right-side, for example, of the application viewport in which the working document 112 is displayed. The side panel can be presented to displace the working document a suitable amount to display the search results in a manner that enables reading by the user 110.

The results 124 can be presented in the authoring application 114 in a panel opened and displayed on a side (e.g., right, left, etc.) of an application viewport in which the working document 112 is presented. Results can be displayed directly in the authoring application because the query is coming from the authoring application. A user query can be received or a query formulated automatically within the authoring application so there is no need to go to a separate application for searching. If the query was not issued from the authoring application, there would need to be an additional link (e.g. user copy-paste) to get the results from an external source into the authoring application, which is not required in this disclosed architecture.

The internal network can comprise one or more local storage(s) (e.g., drive, memory, etc.) of a specific device (e.g., laptop, smartphone, tablet, etc.) of the user 110 and/or an enterprise network. The search 120 is initiated from within the authoring application 114. The search 120 represents all aspects of search such as one or more search engines (for each of internal networks and public networks), ranking, re-ranking, and (document) results processing and output.

The authoring context 108 comprises one or more of in-application session context, textual context, historical logged signals, and context from the device sessions (e.g., applications used before or after, or being used simultaneously).

The user context 106 can be used by an enterprise index and a public index to generate corresponding graph-based features. In one implementation, all content of the current state of the working document 112 is used to find (search) relevant results. This entire content of the working document can be analyzed for features and then represented as a vector of the features for processing as all or part of the contextual query.

Feedback signals 130 can also be employed to improve the architecture. The feedback can comprise how the user interacts with the results returned by the architecture. Positive feedback comprises when the user selects (“clicks”) content or interacts with the content. Feedback signals 130 can be used by the architecture over time to improve ranking (e.g., by tuning the ranker to user preferences).

The system 100 can be deployed in several different ways relative to a personal computing device (e.g., desktop computer, portable computer, smartphone, tablet, etc.), a search engine (network-based), and cloud services.

For example, in a first implementation, the authoring application 114, working document 112, context component 102, overall context 104, query component 118, presentation component 128, and the search 120 can all occur on (e.g., operate on or from) the personal computing device. The search 120 receives the query 116 and the search 120 is then directed by the local operating system or other suitable local program to be performed on the internal and public networks 126 for the results 124. The search 120 can comprise a local search program that communicates the query 116 to an external search engine, which engine then performs the search on the networks 126 and returns the results 124 to the local search program for passing to the presentation component 128 for presentation in the authoring application 114.

In a second implementation, the authoring application 114, working document 112, context component 102, overall context 104, query component 118, and the presentation component 128, can all occur on (e.g., operate on or from) the personal computing device. The search 120 is then performed wholly external to the personal computing device using public and/or corporate (enterprise) search engines. The search 120 receives the query 116 from the query component 128 and executes the query 116 on the internal and public networks 126 and returns the results 124 to the local search program for passing to the presentation component 128 for presentation in the authoring application 114.

A third implementation relates more to cloud (or remote) services. Here, the personal computing device may be a legacy device or more resource-limited as to its capabilities. Thus, the cloud services handle more of the applications and information processing. In an extreme case, most, if not all, of the applications are in the cloud. For example, the user 110 accesses the authoring application 114 in the cloud. The context component 102, the query component 118, the presentation component 128, and the search 120 are also provided as cloud services. In other words, the user 110 can login to the cloud services, and launch the authoring application 114 to work on the working document 112.

The overall context 104 is then derived (in the cloud), and the query 116 formulated and processed in the search 120. The results 124 are returned and presented in the cloud-based authoring application 112. Context identification by the context component 102 can be achieved by communicating with the personal computing device, for example, for information that may contain user interest and behaviors. Alternatively, this information can be stored in the cloud in the user login account and updated as the user interacts with the cloud services. The query component 118 then generates the query 116 according to context/session features and/or receives the user-generated query 116 for search processing.

A fourth implementation relates to the consideration of security issues that may arise when handling enterprise results and public results. In this case, the query 116 can be derived as before using the context component 102 and query component 118; however, the query 116 is sent to both a public network search engine and an enterprise search engine. The results from each engine are ranked and a candidate set then returned from each engine, re-ranked together, and then a final ranked set selected as the results 124 for presentation by the presentation component 128 in the authoring application 114. Alternatively, the ranked public results can be sent to the enterprise search engine for re-ranking.

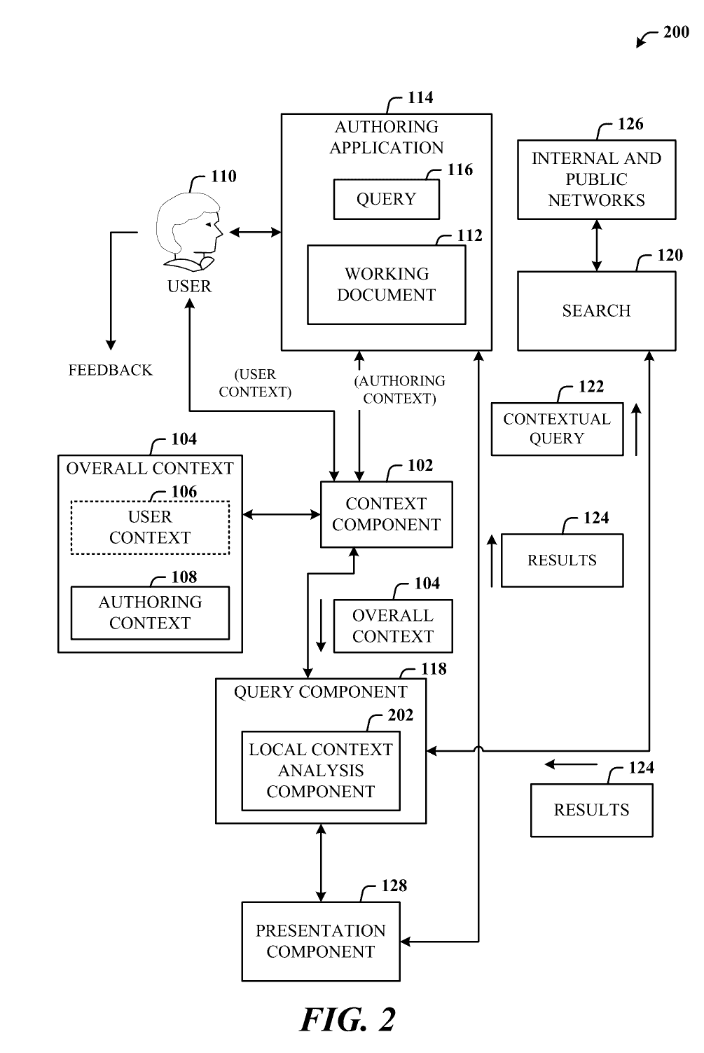

FIG. 2 illustrates an alternative system 200 in accordance with the disclosed architecture. The system 200 can comprise some or all of the components and blocks of system 100 of FIG. 1, as well as a local context analysis component 202. The local context analysis component 202 can be provided and configured to receive the authoring context 108, candidate results from the internal network, and candidate results from the public network (combined as the results 124), and then influence a second level of results ranking of the search 120 in the internal and public networks 126 (e.g., a second level of results ranking in the internal network and a second level of results ranking in the public network). The second level of re-anking can be merging and re-ranking the documents as a whole (i.e., ranking the confluence of enterprise and public documents).

The system 200 can further comprise a neural network (e.g., DNN) as a structured semantic model to rank and/or re-rank candidate documents based on at least one of personalized (user-related) features, context-sensitive features, or context-free features.

It is within the capabilities of the disclosed architecture to also consider not only the authoring application 114, but also other applications launched with the authoring application 114. For example, if the user is authoring a word processing document in a word processor application, yet is engaging an image in the word processing document, it can be the case that an image editing application may also be launched to deal with certain aspects of the image activities of the user in the authoring application 114. Thus, the overall context 104 can now capture multiple-application context. The search 120 can then be further enabled to consider document results for primarily the word processing document, but secondarily, for the image application, as well. Accordingly, the number of search results and rankings can be adjusted for primary and secondary applications.

The system 200 can be deployed in several different ways relative to a personal computing device (e.g., desktop computer, portable computer, smartphone, tablet, etc.), a search engine (network-based), and cloud services, as described above in the several implementations of system 100.

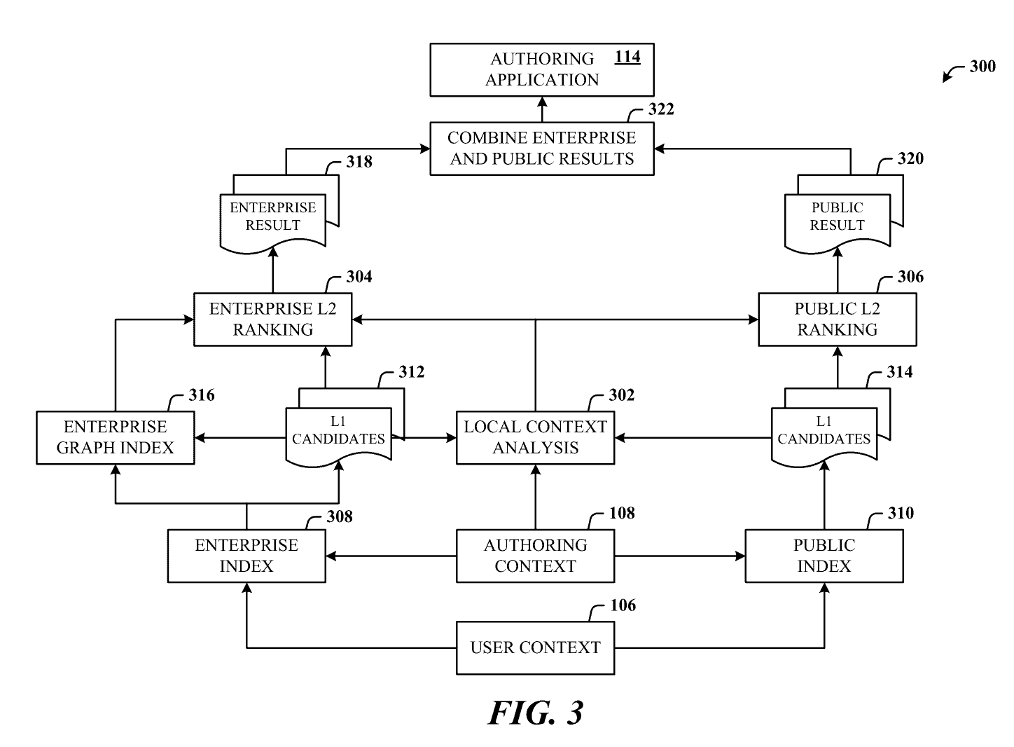

FIG. 3 illustrates an alternative system 300 for context-sensitive content recommendation in accordance with the disclosed architecture. As a general overview of this system 300, note that the user context is “who you are”, “where you are”, “what you are doing”, “when you are doing it”, etc. Authoring context 108 can be the session and textual context when the user is authoring a document. Local context analysis 302 (similar to the local context analysis component 202 of FIG. 2) runs DSSM on top of the authoring context 108, and generates contextual features for the second level (L2) ranking for both the enterprise L2 ranking 304 and public L2 ranking 306. User context 106 is used by both an enterprise index 308 and a public search engine index 310 to generate graph-based features.

Note that L1 is the document-fetching layer. The goal at this layer is, given a query, to return many potential documents (results) from the entire corpus, without losing the top results. The overall relevance of the results at this point may be poor. L2 is the ranking layer, the goal of which is to take the L1 returned documents and the query, and sort the L1 documents so that the best results are first. L1 is typically cheap and fast, while L2 is more computationally expensive. The DSSM is used in the L2 layer for ranking.

As depicted, the user context 106 is input to both the enterprise index 308 and the public index 310. The enterprise index 308 and the public index 310 also both receive the authoring context 108. The enterprise index 308 is used to generate level one (L1) enterprise results candidates 312, and the public index 310 is used to generate L1 public results candidates 314.

The authoring context 108 is input to the local context analysis module 302 (or component), which module 302 also receives the L1 enterprise results candidates 312 and the L1 public results candidates 314.

The L1 enterprise results candidates 312 and the enterprise index 308 are used to create/update an enterprise graph index 316. The enterprise graph index 316, the L1 enterprise results candidates, and features obtained via the local context analysis module 302, are then used for L2 enterprise ranking 304.

On the public side, the public results candidates 314 and the features obtained via the local context analysis module 302 are used for L2 public ranking 306. The L2 enterprise results 318 and the L2 public results 320 are then combined, at 322, and thereafter, passed into the authoring application 114.

It is to be understood that in the disclosed architecture, certain components may be rearranged, combined, omitted, and additional components may be included. For example, with respect to system 100, the context component 102 and query component 118 can collectively be a single application separate from the authoring application 114, or part of the authoring application 114. Alternatively, the context component 102 and query component 118 can be made part of the operating system.

The disclosed architecture can optionally include a privacy component that enables the user to opt in or opt out of exposing personal information. The privacy component enables the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

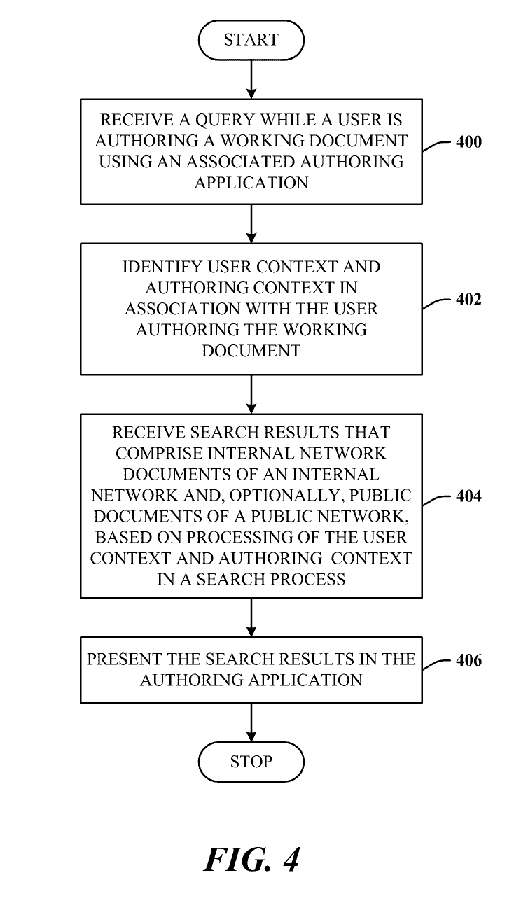

FIG. 4 illustrates a method in accordance with the disclosed architecture. At 400, a query is received while a user is authoring a working document using an associated authoring application. At 402, user context and authoring context are identified in association with the user authoring the working document. At 404, search results are received that comprise internal network documents of an internal network and, optionally, public documents of a public network based on processing of the user context and the authoring context in a search process. At 406, the search results are presented in the authoring application. The user context and the authoring context can be processed in a search process to return search results that comprise internal network documents (as results) of an internal network (e.g., enterprise) and optionally, public documents (as results) of a public network (e.g., the Internet). The user context can be processed to obtain relevant documents, and the authoring context can also be useful in obtaining relevant documents.

The method can further comprise receiving recommended relevant results in the authoring application while the user is authoring the working document. The method can further comprise receiving ranked the search results based on at least one of user feedback, personalized (user) features, context-sensitive features, or context-free features in the query. The method can further comprise receiving re-ranked search results that include merged public network results and internal network results.

The method can further comprise receiving search results based on execution of the authoring context in the query, the search results comprise the internal network documents and documents of a specific user device. The method can further comprise generating document-to-people features as personalized features based on people relationships. The method can further comprise generating contextual feature vectors for the query that represent the authoring context.

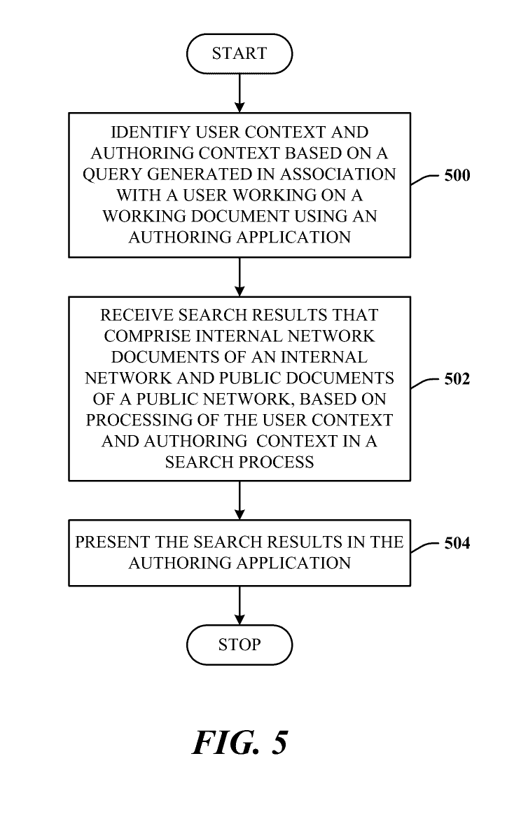

FIG. 5 illustrates an alternative method in accordance with the disclosed architecture. At 500, user context and authoring context is identified based on a query generated in association with a user working on a working document using an authoring application. At 502, search results are received that comprise internal network documents of an internal network and public documents of a public network based on processing of the user context and the authoring context in a search process. At 504, the search results are presented in the authoring application.

The method can further comprise generating the query absent user input or from the user. The method can further comprise enabling insertion of one or more of the search results into the working document via the authoring application.

The method can further comprise receiving ranked search results that include merged public network results and internal network results. The method can further comprise receiving ranked search results based on personalized features, context-sensitive features, and context-free features, as represented by the query.

As used in this application, the term “component” is intended to refer to a computer-related entity, either hardware, a combination of software and tangible hardware, software, or software in execution. For example, a component can be, but is not limited to, tangible components such as one or more microprocessors, chip memory, mass storage devices (e.g., optical drives, solid state drives, magnetic storage media drives, etc.), computers, and portable computing and computing-capable devices (e.g., cell phones, tablets, smart phones, etc.). Software components include processes running on a microprocessor, an object (a software entity that maintains state in variables and behavior using methods), an executable, a data structure (stored in a volatile or a non-volatile storage medium), a module (a part of a program), a thread of execution (the smallest sequence of instructions that can be managed independently), and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

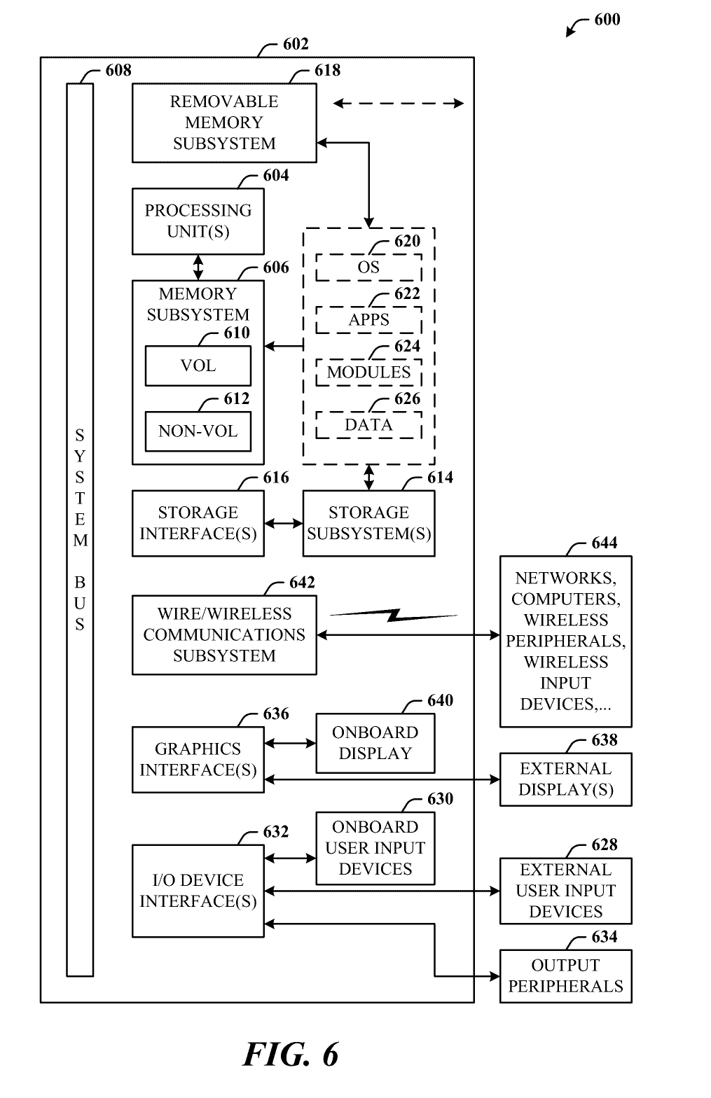

Referring now to FIG. 6, there is illustrated a block diagram of a computing system 600 that executes context-sensitive content recommendation from internal search networks and public search networks in accordance with the disclosed architecture. Alternatively, or in addition, the functionally described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc., where analog, digital, and/or mixed signals and other functionality can be implemented in a substrate.

In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel implementation also can be realized in combination with other program modules and/or as a combination of hardware and software.

The computing system 600 for implementing various aspects includes the computer 602 having microprocessing unit(s) 604 (also referred to as microprocessor(s) and processor(s)), a computer-readable storage medium (where the medium is any physical device or material on which data can be electronically and/or optically stored and retrieved) such as a system memory 606 (computer readable storage medium/media also include magnetic disks, optical disks, solid state drives, external memory systems, and flash memory drives), and a system bus 608. The microprocessing unit(s) 604 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 602 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 606 can include computer-readable storage (physical storage) medium such as a volatile (VOL) memory 610 (e.g., random access memory (RAM)) and a non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the microprocessing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components and circuits. The storage subsystem(s) 614 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The operating system 620, one or more application programs 622, other program modules 624, and/or program data 626 can include items and components of the system 100 of FIG. 1, items and components of the system 200 of FIG. 2, items, components, and flow of the system 300 of FIG. 3, and the methods represented by the flowcharts of FIGS. 4 and 5, for example.

Generally, programs include routines, methods, data structures, other software components, etc., that perform particular tasks, functions, or implement particular abstract data types. All or portions of the operating system 620, applications 622, modules 624, and/or data 626 can also be cached in memory such as the volatile memory 610 and/or non-volatile memory, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 602, and include volatile and non-volatile internal and/or external media that is removable and/or non-removable. For the computer 602, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 602, programs, and data using external user input devices 628 such as a keyboard and a mouse, as well as by voice commands facilitated by speech recognition. Other external user input devices 628 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 602, programs, and data using onboard user input devices 630 such a touchpad, microphone, keyboard, etc., where the computer 602 is a portable computer, for example.

These and other input devices are connected to the microprocessing unit(s) 604 through input/output (I/O) device interface(s) 632 via the system bus 608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

The disclosed architecture can be implemented as a system, comprising: means for receiving a query while a user is authoring a working document using an associated authoring application; means for identifying user context and authoring context in association with the user authoring the working document; means for receiving search results that comprise internal network documents of an internal network and, optionally, public documents of a public network based on processing of the user context and the authoring context in a search process; and means for presenting the search results in the authoring application.

The disclosed architecture can be implemented as an alternative system, comprising: means for identifying user context and authoring context based on a query by a user working on a working document using an authoring application; means for receiving search results that comprise internal network documents of an internal network and public documents of a public network based on processing of the user context and the authoring context in a search process; and, means for presenting the search results in the authoring application.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a context component configured to identify overall context as comprising authoring context in association with a user working on a working document via an authoring application, the overall context identified in association with a query generated while the user is working on the working document;
a query component configured to formulate and facilitate search using the overall context as a contextual query, the search performed using the contextual query alone or in combination with a user query, to obtain at least one of search results that comprise internal network results of an internal network or public results of a public network; and
a presentation component configured to present the search results in association with the authoring application.

2. The system of claim 1, wherein the internal network comprises a local storage of a specific device of the user and an enterprise network.

3. The system of claim 1, wherein the search is initiated from within the authoring application.

4. The system of claim 1, wherein the authoring context comprises session context and textual context.

5. The system of claim 1, wherein the user context is used by an enterprise index and a public index to generate corresponding graph-based features.

6. The system of claim 1, wherein all content of the working document is used to find relevant results.

7. The system of claim 1, wherein the query is initiated from within the authoring application.

8. The system of claim 1, wherein the search results are presented in the authoring application and a search result can be selected and inserted into or appended to the working document.

9. A method, comprising acts of:
receiving a query while a user is authoring a working document using an associated authoring application;
identifying user context and authoring context in association with the user authoring the working document;
receiving search results that comprise internal network documents of an internal network and, optionally, public documents of a public network based on processing of the user context and the authoring context in a search process; and
presenting the search results in the authoring application.

10. The method of claim 9, further comprising receiving recommended relevant results in the authoring application while the user is authoring the working document.

11. The method of claim 9, further comprising receiving ranked search results based on at least one of user feedback. personalized features, context-sensitive features, or context-free features in the query.

12. The method of claim 11, further comprising receiving re-ranked search results that include merged public network results and internal network results.

13. The method of claim 9, further comprising receiving search results based on execution of the authoring context in the query, the search results comprise the internal network documents and documents of a specific user device.

14. The method of claim 9, further comprising generating document-to-people features as personalized features based on people relationships.

15. The method of claim 9, further comprising generating contextual feature vectors for the query that represent the authoring context.

16. A method, comprising acts of:
identifying user context and authoring context based on a query generated in association with a user working on a working document using an authoring application;
receiving search results that comprise internal network documents of an internal network and public documents of a public network based on processing of the user context and the authoring context in a search process; and
presenting the search results in the authoring application.

17. The method of claim 16, further comprising generating the query absent user input or from the user.

18. The method of claim 16, further comprising enabling insertion of one or more of the search results into the working document via the authoring application.

19. The method of claim 16, further comprising receiving ranked search results that include merged public network results and internal network results.

20. The method of claim 16, further comprising receiving ranked search results based on personalized features, context-sensitive features, and context-free features, as represented by the query.
